(19) United States
(12) Patent Application Publication
(10) Pub. No.: US 2007/0295347 A1
(43) Pub. Date: Dec. 27, 2007

(54) Surface-modified porous substrates

(75) Inventors: John B. Paine III, Midlothian, VA (US); Jay A Fournier, Richmond, VA (US); William DeSisto, Orono, ME (US); Robert Cashon, Old Town, ME (US); David Cassidy, Bangor, ME (US)

Correspondence Address: BUCHANAN, INGERSOLL & ROONEY PC, POST OFFICE BOX 1404, ALEXANDRIA, VA, 22313-1404, US

(73) Assignee: Philip Morris USA Inc., Richmond, VA (US)

(21) Appl. No.: 11/707,169

(22) Filed: Feb. 16, 2007

Related U.S. Application Data
(60) Provisional application No. 60/775,339, filed on Feb. 22, 2006.

(51) Int. Cl. B01J 20/22; A24D 3/06

(52) U.S. Cl. 131/342; 131/331; 502/401

(57) ABSTRACT

The surfaces of porous sorbent materials are chemically modified to specifically target the adsorption of select gas phase constituents. More specifically, a functionalized cobalt (II) phthalocyanine-modified porous substrate capable of nitric oxide adsorption from a gas stream is provided. A soluble cobalt (II) phthalocyanine compound can be incorporated in a porous substrate by grafting soluble cobalt (II) phthalocyanine molecules onto a functionalized substrate. In an exemplary case, a cigarette filter element comprises the substrate, which can be an imidazole-functionalized silica gel or an activated carbon of high surface area and permeability, and the gas stream is the mainstream smoke of a cigarette.

### CROSS REFERENCE TO RELATED APPLICATIONS

The present application claims priority under 35 U.S.C. 119 to U.S. Provisional Patent Application No. 60/775,339 filed on Feb. 22, 2006, the entire content of which is hereby incorporated by reference.

### BACKGROUND

Cigarettes produce both mainstream smoke during a puff and sidestream smoke during static burning. Constituents of both mainstream smoke and sidestream smoke contain carbon monoxide (CO) and nitric oxide (NO). Furthermore, emissions from power plants, industrial plants and automobiles contain CO and/or NO. The reduction of levels of carbon monoxide and/or nitric oxide in smoke is desirable. Absorbent and adsorbent materials have been suggested for incorporation into smoking articles, such as cigarettes, for the purpose of removing constituents from mainstream smoke. Porous substrate materials such as activated carbon can be effective in removing a wide spectrum of gas phase constituents from mainstream cigarette smoke when incorporated in cigarette filters, but have little effect on CO and NO.

### SUMMARY

To improve filtration performance (e.g., in cigarette filters), the surface of porous substrates can be chemically modified to specifically target the absorption/adsorption of select gas phase constituents. In an exemplary embodiment, a sorbent comprising a cobalt (II) phthalocyanine-modified porous substrate capable of nitric oxide adsorption from a gas stream is provided. The cobalt (II) phthalocyanine compound can be incorporated in a porous substrate by impregnation, and is preferably incorporated by incorporating cobalt (II) phthalocyanine molecules onto a functionalized substrate.

In embodiments, a cigarette filter element comprises the sorbent, the gas stream is the mainstream smoke of a cigarette, and the filter comprises an amount of sorbent effective to reduce the concentration of nitric oxide in the mainstream smoke.

In further embodiments, the substrate is selected from the group consisting of adsorbent carbon, activated carbon, silica gel, clays, zeolites, mesoporous silicates, and other porous materials, and mixtures thereof. In a preferred embodiment, the substrate is an imidazole-functionalized silica gel. In another preferred embodiment, the substrate is an activated carbon.

In another preferred embodiment, a cigarette filter element comprises the sorbent comprising the modified substrate which is in the form of fibers, particles, granules and/or beads. The particles, granules and/or beads are incorporated in or on a support such as a liner, a plug, a plug wrap, tipping paper, fibrous filter media, fibrous wall portions of a filter element, or cellulose acetate located along and/or within the filter element. The fibers, particles, granules and/or beads can also be located within a hollow cavity sandwiched between conventional cigarette filter elements such as plugs of cellulose acetate, and/or within the cellulose acetate plug itself.

### BRIEF DESCRIPTION OF THE DRAWINGS

FIG. 1 shows a schematic of tetrasulfo- (a) and tetracarboxyl- (b) substituted metal phthalocyanines.

FIG. 2 shows an imidazole-functionalized silica surface formed through reaction with 3-N-imidazolylpropyl triethoxysilane (IPTES), and covalently bonded to a cobalt (II) phthalocyanine derivative, that has captured NO.

FIG. 3 shows a UV-Vis spectrum of cobalt (II) phthalocyanine tetrasulfonic acid-modified imidazole-functionalized silica gel.

FIG. 4 shows nitric oxide breakthrough data for cobalt (II) phthalocyanine tetrasulfonic acid (CoPcTS) impregnated into un-functionalized Qingdao silica gel.

FIG. 5 shows nitric oxide breakthrough data for complexed CoPcTS impregnated into un-functionalized Qingdao silica gel.

FIG. 6 shows nitric oxide breakthrough data for CoPcTS-modified, imidazole-functionalized Qingdao silica gel beads (squares) and similarly-modified Grace-Davison silica gel granules (diamonds).

FIG. 7 shows nitric oxide breakthrough data for CoPcTS-modified, imidazole-functionalized Grace-Davison silica gel granules for gas streams comprising NO (triangles); H₂O and NO (circles); and H₂O, NH₃ and NO (squares).

FIG. 8 shows an equilibrium curve obtained from the multiple NO adsorption analyses for samples prepared using Grace-Davison TCEP functionalized silica gel.

FIG. 9 is a partially exploded perspective view of a cigarette wherein folded paper containing the surface-modified adsorbent is inserted into a hollow portion of a tubular filter element of the cigarette.

FIG. 10 is a partially exploded perspective view of a cigarette wherein the surface-modified adsorbent is incorporated in a plug-space-plug filter element.

FIG. 11 is a partially exploded perspective view of a filter element having surface-modified adsorbent incorporated therein, which may be used to form a cigarette that can be smoked in an electrically-heated cigarette smoking system.

### DETAILED DESCRIPTION OF PREFERRED EMBODIMENTS

Porous substrate materials such as adsorbent carbon, activated carbon, silica gel, zeolites or zeolite-like materials, mesoporous silicates, and mixtures thereof can be used to adsorb gas phase constituents from a gas stream. For example, absorbent and adsorbent materials have been suggested for incorporation into smoking articles, such as cigarettes, for the purpose of removing constituents from mainstream smoke. Porous substrate materials such as activated carbon can be effective in removing a wide spectrum of gas phase constituents from mainstream cigarette smoke when incorporated in cigarette filters. To improve filtration performance (e.g., in cigarette filters), the surface of porous substrate materials can be chemically modified to specifically target the adsorption of select gas phase constituents.

As used herein, the term “porous” means having a plurality of pores, voids or open spaces within the material. “Porous” encompasses materials which have pores on the outer surface as well as pores within the material, but does not make restrictions on the size or shape of the pores. For example, in activated carbon, the voids are often a result of irregularly placed graphene sheets and as such may be more angular than the pores found in a silica gel. Thus the term “porous” as used herein describes a material that has a greater surface area per unit weight than the monolithic or nonporous form of the same material.

Cobalt (II) phthalocyanine (CoPc) compounds can be incorporated in a porous substrate to form a surface-modified adsorbent having enhanced adsorptive affinity for nitric oxide. The sorbents comprising surface-modified adsorbents can be used for selective nitric oxide adsorption and in gas sensors. In one embodiment, the concentration of nitric oxide in a gas stream can be reduced by exposing the gas stream to a sorbent comprising a surface-modified adsorbent. A preferred gas stream comprises the mainstream smoke of a cigarette. In a further embodiment, a sorbent comprising a surface-modified adsorbent can be incorporated in the filter element of a cigarette in an amount effective to reduce the concentration of nitric oxide in mainstream smoke.

A surface-modified adsorbent can be prepared by mixing a high surface area, porous substrate with a solution comprising a CoPc compound under conditions effective to incorporate molecules of the CoPc compound in the pores of the substrate, and then drying the mixture. The CoPc compound, which may comprise a CoPc complex, can be incorporated in a porous substrate by impregnation or by grafting the CoPc molecules onto a functionalized substrate. Aspects of incorporating CoPc compounds into exemplary porous substrates (e.g., activated carbon and silica gel) are discussed below.

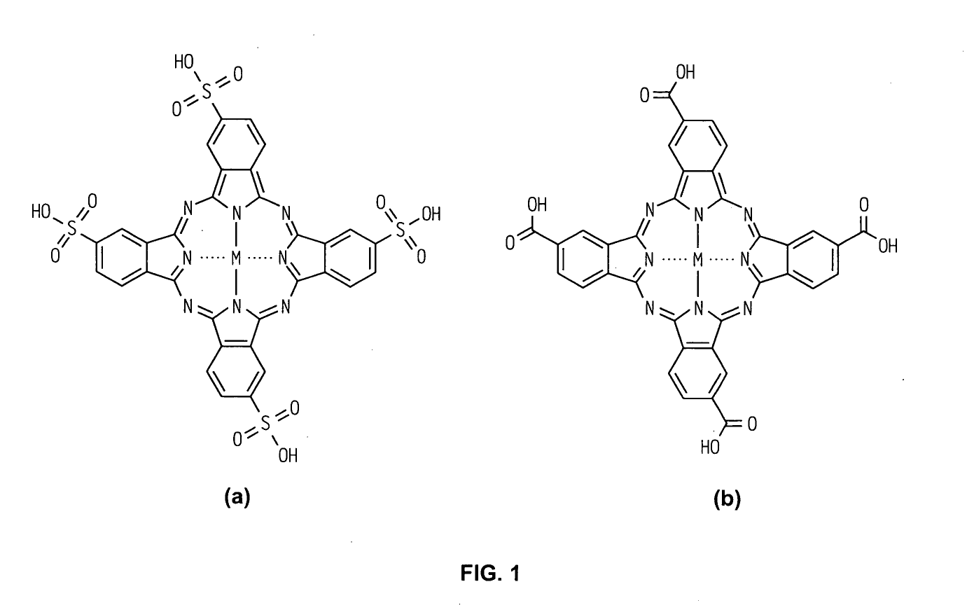

The cobalt (II) phthalocyanine compound is preferably selected to contain solubilizing, derivatizing groups such as carboxylate and/or sulfonate groups. The CoPc compound can comprise cobalt (II) phthalocyanine tetracarboxylic acid, cobalt (II) phthalocyanine tetrasulfonic acid, cobalt (II) phthalocyanine tetraphosphoric acid, cobalt (II) phthalocyanine tetraphosphonic acid and mixtures thereof. Schematic depictions of tetrasulfo- and tetracarboxyl-substituted metal phthalocyanines, comprising the metal phthalocyanine core functionalized with tetracarboxylic acid (a) and tetrasulfonic acid (b) functionality are shown in FIGS. 1a and 1b, respectively, where the metal center which can be occupied by cobalt is labeled “M”. However, it is to be understood that the depicted isomers are merely important components and are generally found admixed with other isomers or homologs (not shown), due to lack of selectivity in the synthesis process. These other isomers or homologs are believed to be of similar performance to the isomers depicted. Cobalt (II) phthalocyanine tetrasulfonic acid is commercially available from Porphyrin Products (Logan, Utah).

An exemplary CoPc compound, cobalt (II) phthalocyanine tetracarboxylic acid, can be prepared by combining trimellitic anhydride (4-carboxyphthalic anhydride) with a stoichiometric amount of cobalt (II) chloride hexahydrate and heating the mixture in excess urea. Preferably, the product, which is a presumed mixture of up to four regioisomers (positional isomers) of cobalt (II) phthalocyanine tetracarboxylic acid, is purified to liberate the carboxy-group moiety from any nitrogenous derivatives. The CoPc molecules can also be mono-, di- or tri-functional with respect to carboxylic or sulfonic groups. The synthesis of CoPc is described in further detail by Moser et al. in “Phthalocyanine Compounds,” American Chemical Society Monograph Series, Reinhold Publishing Corporation, NY (1963), the entire content of which is herein incorporated by reference.

Cobalt (II) phthalocyanine itself has an extremely low solubility in water and a relatively high self-affinity in the solid state. Such self-affinity leads to a strong tendency to crystallize. The resulting crystals are non-porous such that molecules located within the interior of the crystals are unable to access NO effectively. For maximum efficiency in NO removal, therefore, the CoPc needs to be dispersed as close to monomolecularly as can be achieved. Individually-dispersed molecules of CoPc that are incorporated on an exposed surface of a porous substrate can adsorb nitric oxide.

Advantageously, the water solubility of CoPc can be increased significantly by derivatizing the CoPc molecule with suitable functional groups. By placing negatively charged groups such as carboxylate anions or sulfonate anions in as much as one such group in each quadrant of the CoPc molecule, anionic repulsion helps promote the dispersion of individual CoPc molecules away from each other.

According to a preferred embodiment, CoPc molecules are incorporated in a porous support up to a total loading of about 20% by weight, more preferably from about 1 to 10% by weight, most preferably from about 2.5 to 5% by weight. Too high a loading may encourage self-aggregation of the CoPc molecules and an attendant loss in nitric oxide binding capacity. Generally, the nitric oxide binding efficiency of surface-modified substrates (on a per-CoPc basis) decreases with an increase in the loading of CoPc molecules. That is, the rate of increase of binding efficiency decreases with an increase in loading.

Prior to incorporating a CoPc compound into a porous substrate, the CoPc compound, the porous substrate or both can be modified (i.e., functionalized) in order to enhance the dispersion of the CoPc compound on exposed surfaces of the porous substrate.

Cobalt (II) phthalocyanine molecules can be functionalized in order to minimize self-aggregation when the molecules are incorporated into a porous substrate. Sufficient charge repulsion between the molecules can promote the formation of a discrete layer (e.g., monolayer) of CoPc molecules on exposed surfaces of a porous substrate.

Cobalt (II) phthalocyanine molecules can be functionalized by incorporating therein various solubilizing derivatizing groups. Solubilizing derivatizing groups such as sulfonic acid groups or carboxylic acid groups can be incorporated in the CoPc in order to enhance the reactive dispersion of the functional phthalocyanine moiety. Suitable derivatizing groups include any group which, when covalently attached to the CoPc molecule, bring about a useful change in its properties, such as its solubility in aqueous media. For example, charge repulsion among the carboxylate anions may contribute to achieving an effective dispersion of CoPc tetracarboxylate salt throughout the pores of activated carbon, while minimizing the self-aggregation of the CoPc.

Solubilizing derivatizing groups can be incorporated in CoPc molecules during or after the synthesis of the CoPc core.

An unintended consequence of incorporating solubilizing derivatizing groups is that incorporation of the groups will increase the molecular weight of the CoPc molecule. For example, addition of tetrasulfonic acid or tetracarboxylic acid functionality will increase the molecular weight of CoPc from 571 Daltons to 891 Daltons and 747 Daltons, respectively.

The porous substrate can be one or more of carbon, activated carbon, silica gel, clays, zeolites, zeolite-like materials, and mesoporous silicates, and can be in monolithic or particulate form. To form a surface-modified adsorbent, the substrate material can be mixed with a liquid solution containing a CoPc compound under conditions effective to incorporate the CoPc molecules into the pores of the support. After infiltration of the CoPc molecules into the substrate, the infiltrated particles can be dried under a flowing gas such as air or nitrogen to obtain impregnated support particles having a desired loading of derivatized CoPc.

A preferred porous substrate is activated carbon. The term “activated carbon” is used in the conventional sense to mean any porous or high surface area form of carbon, wherein the carbon self-bonding is primarily by sp²-hybridization. Wherein CoPc molecules are prone to self-aggregation, the graphene sheets in activated carbon can bind the phthalocyanine groups in parallel-planar fashion, blocking one axial position of the phthalocyanine moiety but leaving the other axial position free to react with nitric oxide. In a preferred embodiment, the CoPc molecules form a monolayer coating on exposed surfaces of the porous substrate.

Activated carbon can be derived via thermal treatment of any suitable carbon source. The activation treatment typically increases the porosity thereby increasing the surface area per unit weight and thus the adsorptivity of the carbon. Activated carbon can therefore be denoted by its adsorptive properties, e.g. using ASTM D3467, the Standard Test Method for Carbon Tetrachloride Activity of Activated carbon. Preferably, the activated carbon substrate has an ASTM D3467 value of greater than 80%, and more preferably from 90% to 100%. Although difficult to measure, the BET surface area of the activated carbon substrate is preferably greater than 1200 m²/g, but this number may vary depending on testing conditions.

The activated carbon substrate is preferably in the form of fibers, particles, granules and/or beads (i.e. “particles”). The particle sizes for the activated carbon preferably range from about 35×60 mesh to about 20×50 mesh.

Prior to incorporating CoPc molecules into activated carbon, the activated carbon is optionally acid-washed. The activated carbon can be acid-washed in hydrochloric acid and dried in order to minimize the amount of potassium and calcium salts in the activated carbon. The acid washing may also reduce the amount of dusty fines in the activated carbon sample.

To obtain acid-washed activated carbon, a sample (approximately 260 g) of PICA RC-259 activated carbon (PICA, USA, Columbus, Ohio) was treated with an aqueous solution of hydrochloric acid (103 mL HCl diluted with de-ionized water to 1 liter). The carbon was allowed to soak in the solution for 2.5 hours without stirring after which the supernatant liquid was decanted off and the remainder allowed to stand for an additional 0.5 hours before effecting the filtration step. The acid-washed solids were collected by filtering off the liquid and washing the solids with 4 liters of de-ionized water. The solids were left drying overnight under suction in an 18.5 cm diameter Buchner funnel. The resulting solids were further dried overnight in an oven at 110° C. The total yield of acid-washed activated carbon was about 249 g.

An aqueous solution of a CoPc compound was prepared by dissolving cobalt (II) phthalocyanine tetracarboxylic acid in water to which excess ammonium hydroxide had been added. In accordance with a preferred method, the cobalt (II) phthalocyanine compound was incorporated into particles of activated carbon by mixing the activated carbon with a boiling ammoniacal solution of the cobalt (II) phthalocyanine tetracarboxylic acid. A loading of up to about 5 wt % of the CoPc compound was obtained by reacting the activated carbon with the CoPc solution for a period of several hours. Higher levels (up to about 10 wt %) of the phthalocyanine salt can be incorporated into the activated carbon by boiling the solution down to dryness in the presence of the activated carbon to be loaded. Various examples of loading of functionalized CoPc onto activated carbon substrates follow:

A surface-modified adsorbent comprising a 2.5 wt % loading of cobalt (II) phthalocyanine tetracarboxylic acid into acid-washed activated carbon was prepared as follows:

Cobalt (II) phthalocyanine tetracarboxylic acid (0.52 g) and ammonium hydroxide (3.81 g) were mixed in 100 mL of water and stirred at room temperature overnight. The resulting solution was added to 20.4 g of acid-washed activated carbon. The mixture was refluxed in a heavy-walled Erlenmeyer flask atop a hotplate for 5 hours during which time all of the color in the solution was adsorbed by the activated carbon. The resulting surface modified carbon was filtered, rinsed with water, and dried in air at room temperature.

A surface-modified adsorbent comprising a 5 wt % loading of cobalt (II) phthalocyanine tetracarboxylic acid into acid-washed activated carbon was prepared as follows:

Cobalt (II) phthalocyanine tetracarboxylic acid (1.03 g) and ammonium hydroxide (3.36 g) were mixed in 100 mL of water and stirred at room temperature for 2.5 hours. The resulting solution was added to 20.1 g of acid-washed activated carbon. The mixture was refluxed in a heavy-walled Erlenmeyer flask atop a hotplate for 8 hours during which time most of the color in the solution was adsorbed by the activated carbon. The resulting surface modified carbon was filtered, rinsed with water, and dried in air at room temperature.

A surface-modified adsorbent comprising a 5 wt % loading of cobalt (II) phthalocyanine tetracarboxylic acid into activated carbon was prepared as follows.

Cobalt (II) phthalocyanine tetracarboxylic acid (1.02 g) and ammonium hydroxide (6.55 g) were mixed in 100 mL of water and the solution was refluxed for 4.5 hours. Approximately 20 g of activated carbon was added to the solution and the resulting mixture was refluxed for 6 days. The solids were rinsed with water (500 mL) and air dried to form a surface modified carbon.

A surface-modified adsorbent comprising a 10 wt % loading of cobalt (II) phthalocyanine tetracarboxylic acid into acid-washed activated carbon was prepared as follows:

Cobalt (II) phthalocyanine tetracarboxylic acid (2.01 g) and ammonium hydroxide (1.62 g) were mixed in 100 mL of water and stirred at room temperature until the solids were completely dissolved. The resulting solution was filtered and to the filtrate was added 20 g of acid-washed activated carbon. The mixture was allowed to stand at room temperature for about 48 hours, and then the mixture was heated atop a hotplate for 2 days during which time the majority of the water was gradually distilled off. The remaining water with the resulting surface modified carbon was removed under a stream of nitrogen gas.

A surface-modified adsorbent comprising an about 5 wt % loading of cobalt (II) phthalocyanine tetracarboxylic acid into MAST Novacarb™ activated carbon beads was prepared as follows:

Cobalt (II) phthalocyanine tetracarboxylic acid (1.00 g) and ammonium hydroxide (8.20 g) were combined with 205 mL of water and 20.035 g of 40-60 mesh MAST Novacarb™ 5-250/425-E5-45C beads and refluxed for five days. By spectrophotometry, more than 90% of the acid was adsorbed. The beads were filtered off, rinsed with about 200 mL of water and dried in air. The yield was 23.47 g.

A surface-modified adsorbent comprising a 5 wt % loading of sulfonated cobalt (II) phthalocyanine into acid-washed Pica RC-259 activated carbon was prepared as follows:

200.03 g of the ammoniacal 0.5% stock solution of sulfonated cobalt (II) phthalocyanine (from Example 3, see below) was added to 20.06 g of acid-washed activated carbon along with a 2.0 mL water rinse and refluxed for about 24 hours. By UV/Vis spectrophotometry, over 99% of the cobalt (II) phthalocyanine sulfonate was adsorbed. The product was filtered off, rinsed with minimal water, and dried in air at room temperature. Yield of the resulting hydrous sample was 29.68 g, from which a 17.06 g sample was dried to constant weight in an oven yielding 11.67 g.

Another preferred porous substrate is silica gel. CoPc molecules can be impregnated into the pores of a silica gel substrate or covalently grafted onto functionalized silica gel. CoPc molecules are preferably incorporated into porous silica gel by immersing the functionalized silica gel in a solution comprising the CoPc molecules.

Silica gel beads such as those available from Qingdao Haiyang Chemical Company Ltd. (Qingdao, China) and silica gel granules such as those available from Grace-Davison (Columbia, Md.) can be used as a porous support. Exemplary silica gel beads from Qingdao Haiyang Chemical Co. have an average size of about 300-700 microns and an average pore size of from about 100 to 150 Angstroms. Exemplary silica gel granules from Grace-Davison have an average size of about 250 to 500 microns and an average pore size of about 150 Angstroms or greater. Speculatively, the larger average pore size of the Grace-Davison particles may allow CoPc molecules to bind deeper within the pores, which can create a more effective nitric oxide adsorbent. Crowding of CoPc near the pore mouths of the Qingdao silica gel may result in less extensive incorporation of CoPc molecules, and as a result, a less effective nitric oxide adsorbent. Commercially-available silica gel granules or commercially-available silica gel beads were used as the porous carrier (i.e., substrate) to form surface modified adsorbent particles. The particle sizes for both the Qingdao silica gel and the Grace-Davison ranged from about 35×60 mesh to about 20×50 mesh.

In a further synthesis example, cobalt (II) phthalocyanine tetrasulfonic acid or cobalt (II) phthalocyanine tetracarboxylic acid can be incorporated into silica gel particles to form a surface-modified adsorbent. Advantageously, the silica gel is derivatized (functionalized) prior to incorporating the CoPc salt therein. CoPc molecules are prone to self-aggregation when mixed in solution with ordinary silica gel. By derivatizing the silica gel, self-aggregation of the CoPc molecules can be minimized and an effective dispersion of the CoPc molecules throughout the pores of the silica gel can be achieved.

Applicants have discovered that the gas-phase nitric oxide affinity of CoPc-modified silica gel can be substantially improved by derivatizing the silica gel prior to incorporating CoPc molecules therein. A preferred derivatizing agent for silica gel comprises an imidazole group. For example, the direct adsorption of nitric oxide from a gas stream by CoPc-modified imidazole-functionalized silica gel was up to about two orders of magnitude greater than the nitric oxide adsorption of samples comprising CoPc-containing un-derivatized silica gel. The un-derivatized silica gel samples included functionalized CoPc incorporated into un-functionalized silica gel or functionalized CoPc molecules incorporated into un-functionalized silica gel in the presence of unbound imidazole molecules. Another preferred derivatizing agent for silica gel comprises a pyridine group.

An aqueous or other solvent solution of the derivatizing compound can be sprayed onto the silica gel, or the silica gel may be immersed in the solution. “Aqueous” as used herein refers to mixtures (e.g., solutions and emulsions) that comprise water as a component. An aqueous mixture can also include organic solvents, which are either miscible or immiscible with water.

The concentration of the derivatizing compound in the solvent can be up to the saturation concentration at the chosen temperature. A preferred solution of the derivatizing compound comprises up to about 10 wt % of the derivatizing compound in a suitable solvent, or up to saturation, whichever is less. Suitable solvents include propylene glycol, alcohols (e.g., methyl alcohol, ethyl alcohol, etc.), water, glycerin and mixtures thereof. A preferred solvent for the derivatizing compound is water. After coating the substrate with a solution of the derivatizing compound, the pre-treated substrate can be air dried and/or dried in an oven at low temperature (e.g., less than about 250° C., preferably about 150° C., more preferably about 100° C. to form a derivatized substrate. The derivatizing compound is preferably incorporated over an exposed surface of the substrate. Silica gel can be derivatized by treating with a derivatizing compound such as 3-(1-imidazolyl)-propyltriethoxysilane (IPTES). By way of example, silica gel beads can be refluxed at 90° C. for 24 hours in a 15 mM toluene solution of IPTES and then baked dry at 100° C. for 24 hours in order to derivatize the silica gel beads with imidazole. A preferred loading of imidazole in the silica gel beads corresponds to about 10⁻³ gram-atoms of nitrogen per gram of silica gel (e.g., from about 1×10⁻³ gram-atoms to 3×10⁻³ gram-atoms of nitrogen/gram).

In an exemplary synthesis of surface-modified silica gel, 0.5 g of imidazole-functionalized silica gel is added under constant stirring to an aqueous solution of (II) phthalocyanine tetrasulfonic acid (CoPcTS) (0.0635 g of CoPcTS tetrasodium salt (CoPcTS Na₄) in 15-30 mL of 18 MΩ-cm de-ionized water). The mixture is preferably stirred at constant temperature (e.g., room temperature, 30, 40, 50, 60 or 70° C.) for a fixed period of time (e.g., 6, 12, 24, 48 or 96 hours or until the solution is evaporated). This synthesis results in a loading of CoPc molecules to functionalized silica gel of about 12.7 wt % (wt. of CoPcTS Na₄ salt to wt. of gel ratio).

Optionally, for the synthesis of samples comprising un-functionalized silica gel beads, the Cobalt (II) phthalocyanine compound can be complexed via addition to the solution of a complexing agent such as L-histidine, 4-methyl-imidazole or imidazole, which are available from Aldrich Chemical Company (Milwaukee, Wis.).

Preferably, the loading of CoPc molecules in functionalized silica gel is up to about 20 wt %. CoPc loadings up to about 13 wt % can be obtained by evaporating down the mixture until dry. Higher level loadings (up to about 20 wt %) can be achieved by crushing the silica gel. Speculatively, the loading of CoPc molecules into silica gel to levels above 13% is limited by diffusion of the CoPc molecules into the pores and/or by a limited number of imidazole sites that participate in binding the CoPc molecules to the substrate.

The extent of loading of Cobalt (II) phthalocyanine molecules into silica gel can be determined by measuring the concentration of CoPc remaining after impregnating the silica gel with the CoPc-containing solution. The remnant concentration of CoPc can be measured using UV-Vis spectroscopy. Furthermore, CoPc compounds loaded onto silica gel and grafted onto imidazole-functionalized silica gel can be characterized using a fiber optic based reflection UV-Vis spectrophotometer (Ocean Optics, Dunedin, Fla.).

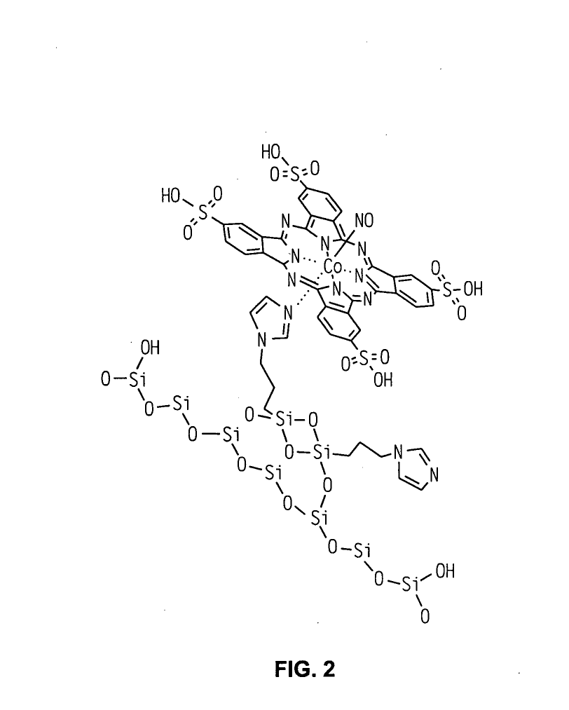

Preferably, each Cobalt (II) phthalocyanine molecule that is incorporated into derivatized silica gel binds to only one imidazole group, which leaves one axial ligand position of each Cobalt (II) phthalocyanine molecule available to bind to nitric oxide. A schematic of an imidazole-functionalized silica surface covalently bonded to a CoPc derivative that has captured NO is shown in FIG. 2.

The BET surface areas of as-received silica gels and imidazole-functionalized silica gels (both with and without Cobalt (II) phthalocyanine tetrasulfonic acid modification) are shown in Table 1. In Table 1, the imidazole-functionalized silica gel samples are abbreviated with the annotation “Im” for imidazole, and the Cobalt (II) phthalocyanine tetrasulfonic acid-modified silica gel samples are abbreviated with the annotation “CoPcTS” for Cobalt (II) phthalocyanine tetrasulfonic acid. As shown in Table 1, by functionalizing the silica gel with IPTES, the surface area decreases by about 40%. FTIR analysis of the imidazole-functionalized silica gel beads showed C—H stretching in the region of about 2900 cm⁻¹, which is consistent with imidazole functionalization. The surface area decreased further with the addition of Cobalt (II) phthalocyanine tetrasulfonic acid to the functionalized silica gel.

TABLE 1

| Silica Gel Sample | Surface Area (m²/g) |
|---|---|
| Qingdao beads | 452 |
| Grace-Davison granules | 297 |
| Im-Qingdao beads | 261 |
| Im-Grace-Davison granules | 179 |
| CoPcTS-Im-Qingdao beads | 165 |
| CoPcTS-Im-Grace-Davison granules | 131 |

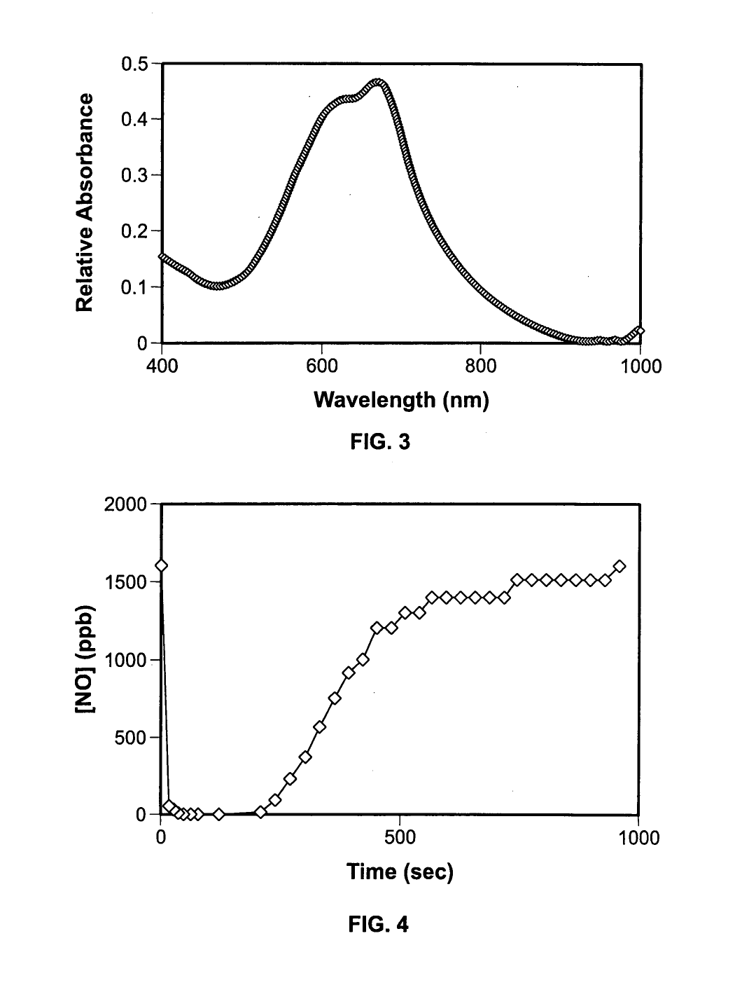

The diffuse reflectance UV-Vis spectrum for CoPcTS grafted onto imidazole-functionalized Qingdao silica is shown in FIG. 3. The absorption bands at 600-680 nm are consistent with the spectra for the CoPcTS molecule. These absorption bands correspond to the Q bands that arise from π-π* transition in the phthalocyanine ring. The CoPcTS molecule remains intact when grafted onto silica gel.

For CoPcTS in an aqueous solution, the Q_{α} band appears at 660 nm and the Q_{β} band appears as an inflection of the Q_{α} band between 630 and 650 nm. When imidazole is added to the CoPcTS solution, the Q_{α} band shifts from 660 to 665 nm, which is consistent with the formation of an imidazole-CoPcTS complex. The electronic absorption of tetrasulfonated phthalocyanine molecules in aqueous solution can be explained in terms of a monomer-dimer equilibrium where the monomeric species absorbs electromagnetic radiation at a higher energy than the dimeric species.

Nitric oxide breakthrough data can be obtained by placing a known mass of a surface-modified adsorbent in an adsorption column, flowing a dilute NO stream over the sample and analyzing the effluent using a NO analyzer (Seivers Instruments, Inc., Boulder, Colo.). Typically, the sample (e.g., 50 mg of surface-modified adsorbent) is placed in a vertical adsorption column on a porous metal frit and a dilute NO stream (e.g., 5 ppm NO in N₂) is flowed at a constant flow rate (e.g., 50 to 100 sccm) down through the column. The concentration of NO in the effluent is measured every second for a period of time up to about 8 hours. Nitric oxide desorption experiments were performed at 80° C. under flowing nitrogen.

In order to assess the efficacy of the surface-modified adsorbents in the presence of potential competitive gas phase interferents, air, or a water vapor-ammonia mixture was added to the gas flow. When air was added to the nitric oxide/nitrogen flow, it comprised 20% of the total gas flow. In order to introduce a water vapor-ammonia mixture to the gas flow, the 5 ppm NO/N₂ gas mixture was bubbled through a glass bubbler containing a 0.01M aqueous solution of NH₄OH. Assuming that the carrier gas (NO/N₂ mixture) was saturated with vapor from the bubbler, the concentrations of the gases and vapors in the mixed stream (in moles per liter) were calculated to be: NH₃: 6.6×10⁻⁴; H₂O: 1.0×10⁻³; NO: 2.2×10⁻⁷; and N₂: 4.5×10⁻² for a gas flow rate of 50 sccm.

In a control experiment, without the surface-modified adsorbent added to the adsorption column, the concentration of NO introduced to the column was determined to be the same both for the 5 ppm NO/N₂ gas mixture flowed through the bubbler and for the 5 ppm NO/N₂ gas mixture flowed directly into the column.

A first comparative sample was made by impregnating CoPcTS Na₄ into un-derivatized Qingdao silica gel by dissolving CoPcTS Na₄ in water and mixing the solution with as-received silica gel particles. The corresponding NO breakthrough data is shown in FIG. 4. The volume of NO adsorbed using the first comparative sample was 4.1×10⁻⁷ mol·cm⁻³ with a corresponding molar ratio of nitric oxide adsorbed to cobalt of about 0.0085 (0.85%). For an ideal adsorbent, the ratio of nitric oxide to cobalt is unity, meaning that each cobalt center is responsible for binding one nitric oxide molecule. The lack of effective NO adsorption by the first comparative sample may be due to Co—Co interactions and/or oligomerization of the CoPc molecules, which is known to occur for CoPcTS in solution at elevated concentrations, or to low general affinity for NO by uncomplexed CoPcTS.

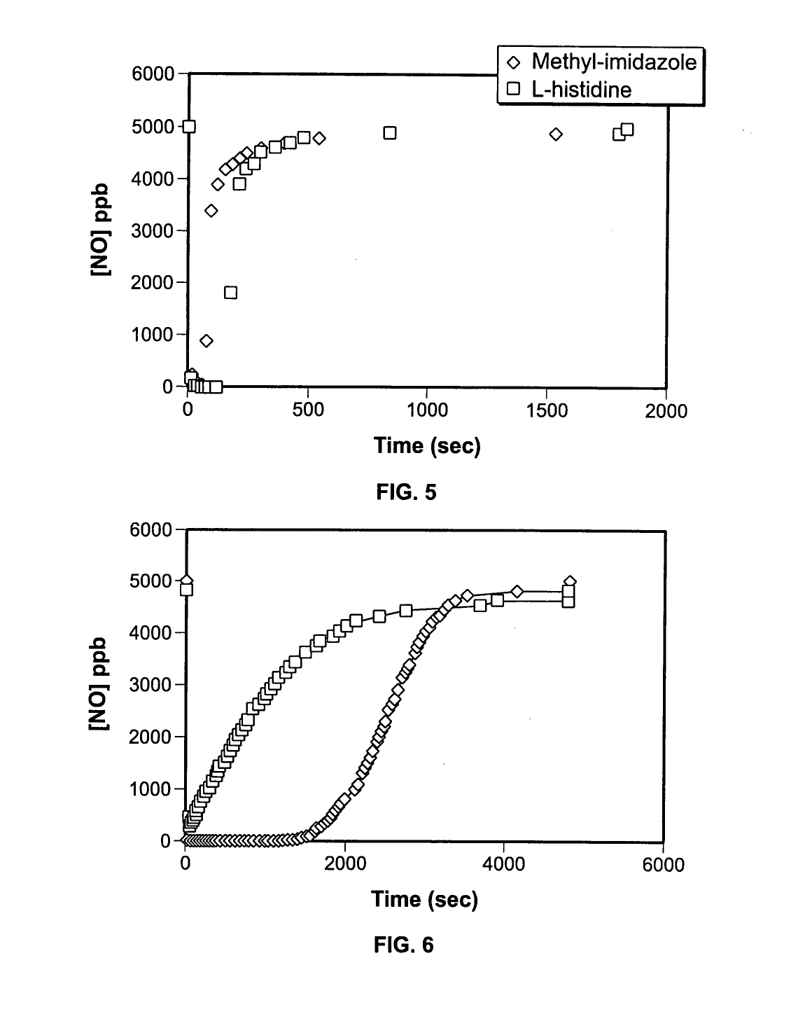

A second set of comparative samples was made by complexing CoPcTS Na₄ with either 4-methyl imidazole or L-histidine prior to impregnating the complexed CoPcTS into un-derivatized silica gel. Three different molar ratios of complexing agent to CoPcTS were investigated: 10:1; 1:1; and 1:2. The maximum NO adsorption was observed at the 1:1 ratio. Nitric oxide breakthrough data for silica gel impregnated with the 1:1 ratio of both 4-methyl imidazole and L-histidine complexed CoPcTS is shown in FIG. 5. For the methyl imidazole complexed sample, the volume of adsorbed NO was 5.9×10⁻⁷ mol·cm⁻³ with a corresponding nitric oxide to cobalt molar ratio of about 1.4% For the L-histidine complexed sample, the volume of adsorbed NO was 6.4×10⁻⁷ mol cm⁻³, with a corresponding to a nitric oxide to cobalt molar ratio of about 1.5%.

The poor nitric oxide adsorption efficiency of the second set of comparative samples may be explained in view of the thermodynamics of the reaction between CoPcTS and imidazole, which favors the formation of the doubly substituted CoPcTS(Im)₂ over the monsubstituted CoPcTS (Im), frustrating the binding of NO. Speculatively, the monosubstituted CoPcTS (Im) is prone to disproportionate in accordance with Eqn 1:
2 CoPcTS(Im) [symbol] CoPcTS(Im)₂+CoPcTS (1)
in which the formation of CoPcTS (Im)₂ and CoPcTS are strongly favored over CoPcTS (Im). In accordance with Eqn. 1, the CoPcTS (Im) species, having a high affinity for NO, prefers to form equimolar proportions of CoPcTS (Im)₂ and CoPcTS, neither of which have significant affinity for NO. This disproportionation can be frustrated if the CoPcTS (Im) species are forcibly kept apart from one another. Such can only be achieved if the imidazole groups are securely anchored far enough apart from each other, such that only one group is within range of any phthalocyanine moiety.

Nitric oxide breakthrough curves for CoPcTS grafted onto imidazole-functionalized silica gel are shown in FIG. 6. The functionalization of silica gel with imidazole provides a site to bind the metal center of a CoPcTS molecule to the support. Breakthrough curves for samples prepared using Qingdao functionalized silica gel (squares) and Grace-Davison functionalized silica gel (diamonds) are shown together for comparison. The CoPcTS loading into the different silica gels was about 10 wt %. The volume of NO adsorbed by the Qingdao silica gel sample was 3.3×10⁻⁶ mol·cm⁻³ and the volume of NO adsorbed by the Grace-Davison silica gel sample was 6.8×10⁻⁶ mol·cm⁻³. The corresponding molar ratios of nitric oxide to cobalt were significantly greater, at 6.8% and 16%, respectively. The adsorption inefficiency, which is manifested as a nitric oxide to cobalt ratio less than unity, may be due to oligomerization of the CoPcTS molecule, disubstitution of some of the CoPcTS by the imidazole content, disproprortionation driven by excessive closeness of the imidazole functionalities on the silica gel, and/or incomplete diffusion of nitric oxide into the pores of the support. However, nitric oxide adsorption by these CoPc-modified, imidazole-functionalized silica gel samples, is substantially better than the nitric oxide adsorption of the first and second comparative samples. Un-derivatized CoPc-modified silica gel exhibited very poor nitric oxide affinity. Equilibrium data indicates that nitric oxide adsorption by CoPc-modified, imidazole-functionalized silica gel was highly favorable, approaching irreversible adsorption.

Experiments suggested that ammonia does not compete with nitric oxide for the axial ligand positions of the CoPc, which are responsible for binding nitric oxide, so it can be used in the synthesis of surface-modified adsorbents without deactivating or impairing the subsequent reactivity with the gas.

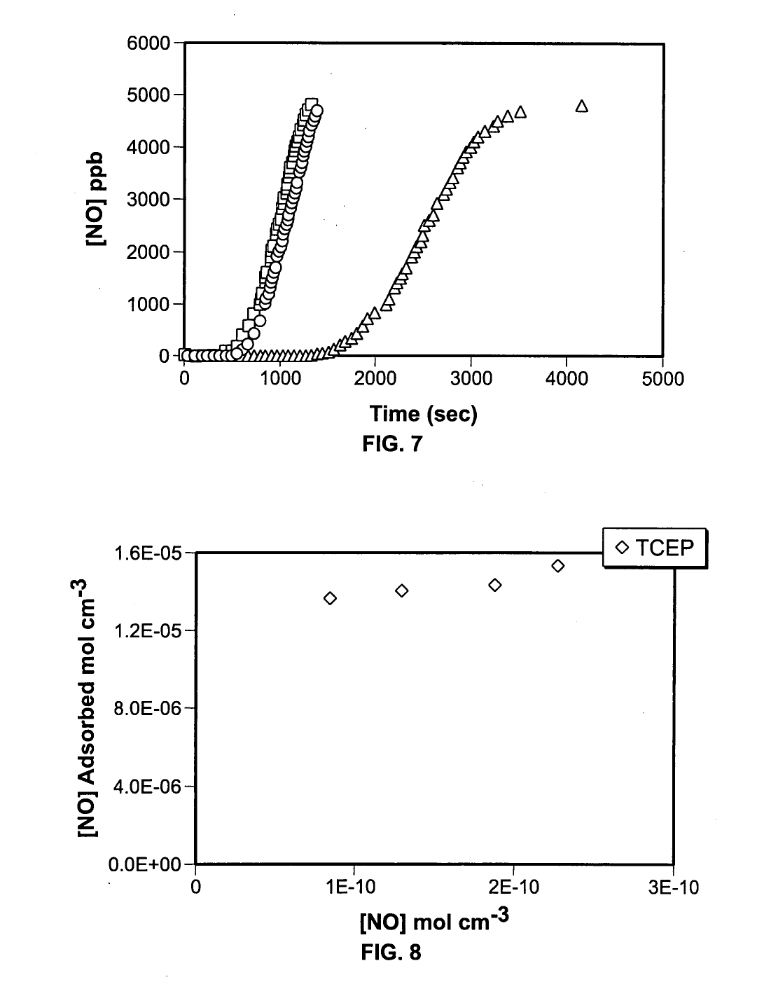

This was tested by measuring the effects of including a water vapor-ammonia mixture in the NO/N₂ gas stream on the nitric oxide adsorption properties of CoPcTS-modified, imidazole-functionalized Grace-Davison silica, and is shown in FIG. 7. High ratios in the input gas stream of H₂O to NO of 4.5×10³, and of NH₃ to NO of 3.0×10³ were used. Data corresponding to the water vapor-ammonia mixture are shown as squares. For comparison, NO adsorption data without the introduction of the water vapor-ammonia mixture (triangles) are also shown in FIG. 7. The presence of the water vapor and ammonia mixture reduce the binding capacity of the CoPcTS-Im-Silica gel by about 75%. Testing with water vapor alone (circles) reduced the binding capacity by about the same amount, suggesting that ammonia does not interfere with nitric oxide adsorption.

In general, however, while the different interferents reduced binding capacity by different amounts, there was a relatively low reduction in binding capacity in the presence of a high concentration of potential interferents in all cases. The data indicated that adsorbent material based on the covalent bonding of CoPcTS by imidazole-functionalized mesoporous silica gel is selective for nitric oxide in the presence of oxygen, water vapor and ammonia.

Another preferred derivatizing agent for silica gel comprises 4-[2-(trichlorosilyl)ethyl]-pyridine (TCEP), available from Gelest, Inc., (Morrisville, Pa.). The functionalization of silica gel with TCEP provides a site to bind the metal center of a CoPcTS molecule to the support. Several samples of this compound were reacted with CoPcTS. The resulting compound had similar NO adsorption characteristics to the CoPcTS-modified imidazole-functionalized silica gel. An equilibrium curve obtained from the multiple NO adsorption analyses for samples prepared using Grace-Davison TCEP functionalized silica gel is shown in FIG. 8. Equilibrium data were extracted from the NO response curves obtained at varying initial NO concentrations taken at 298 K. The data taken over the concentration region shown indicate the adsorbed concentration is in the favorable range for adsorption.

The surface-modified adsorbents can selectively filter nitric oxide from mainstream cigarette smoke. The term “mainstream” smoke includes the mixture of gases and aerosolized particles passing down the tobacco rod and issuing through the filter end, i.e., the amount of smoke issuing or drawn from the mouth end of a smoking article during smoking of the smoking article. The mainstream smoke contains gases that are drawn in through the lit region of the cigarette, as well as through the paper wrapper.

Nitric oxide sorbents comprising the CoPc-modified substrates may be used in a variety of applications, including cigarettes to reduce the concentration of nitric oxide in a gas stream. In a cigarette comprising the nitric oxide sorbent, the modified substrates are preferably particles, granules, and/or beads located in the cigarette filter. Based on the molecular weight ratio of CoPcTS (891 Daltons) and CoPcTC (747 Daltons) to nitric oxide (30 Daltons), and assuming 100% filtration efficiency, in order to remove 300 μg of nitric oxide from a gas stream by stoichiometric reaction, such quantities as at least 8910 μg (8.91 mg) of CoPcTS, or at least 7470 μg (7.47 mg) of CoPcTC, should be exposed to the gas stream. A typical cigarette may thus include from about 10 mg to about 200 mg of the CoPc-modified particles, although the amount needed can also be determined by routine experimentation and/or adjusted accordingly.

Table 2 sets forth data showing reduction of nitric oxide in mainstream smoke of test cigarettes comprising the sorbent compared to that of control samples. The data shows that the sorbent comprising activated carbon (excluding MAST beads) reduced NO by 56% to 83% while the silica gel sorbent reduced NO by 63% and 73%, indicating comparable adsorption. Similarly, no clear difference in adsorption could be seen between the sorbent comprising a CoPc compound derivatized by a carboxylate group (“carboxylated” CoPc) and the sorbent comprising the compound derivatized by a sulfonate group (“sulfonated” CoPc).

Test cigarettes had a 12 mm cavity for the adsorbent. The normal carbon was removed from the cavity and replaced with either the analyte adsorbent or with the control, with weights taken to provide equal bed-volumes of adsorbent. All Silica 646 with CoPcTS on them were previously derivatized by the addition of 3-(1-imidazolyl)-propylsilyl groups. Cigarette test models were smoked along with four replicates, and the average value of the five is reported in micrograms.

TABLE 2

| | | | Mean Nitric | Standard | Reduction |
|---|---|---|---|---|---|
| Carbon or Silica | Derivative | Weight | Oxide (μg) | Deviation | vs. Control |
| Activated carbon Acid Washed | 2.5% CoPcTC | 185 mg | 56 | 23 | 56% |
| Activated carbon Acid Washed | 5.0% CoPcTC | 190 mg | 49 | 11 | 62% |
| Activated carbon Acid Washed | Control | 180 mg | 128 | 14 | |
| Activated carbon Acid Washed | 2.5% CoPcTC | 185 mg | 38 | 8 | 70% |
| Activated carbon Acid Washed | 5.0% CoPcTC | 190 mg | 49 | 8 | 61% |
| Activated carbon Acid Washed | Control | 180 mg | 127 | 14 | |
| Activated carbon Unwashed | 5.0% CoPcTC | 190 mg | 15 | 5 | 83% |
| Activated carbon Unwashed | Control | 180 mg | 90 | 14 | |
| Activated carbon Acid Washed | 5.0% CoPcTC | 190 mg | 15 | 5 | 81% |
| Activated carbon Acid Washed | Control | 180 mg | 77 | 16 | |
| Activated carbon Acid Washed | 4.5% CoPcTS | 200 mg | 19 | 6 | 75% |
| Activated carbon Acid Washed | Control | 180 mg | 77 | 13 | |
| Activated carbon Acid Washed | 5.0% sulfon CoPc wet | 267 mg | 19 | 11 | 78% |
| Activated carbon Acid Washed | Control | 180 mg | 86 | 10 | |
| Activated carbon Acid Washed | 5.0% sulfon CoPc dry | 183 mg | 13 | 5 | |
| Activated carbon Acid Washed | 5.0% sulfon CoPc dry | 90% fill | 31 | 15 | 66% |
| Activated carbon Acid Washed | Control | 90% fill | 91 | 9 | |
| MAST Beads | CoPcTC | 188 mg | 43 | 11 | 39% |
| MAST Beads | Control | 161 mg | 70 | 9 | |
| Silica 646 | CoPcTS (Im-subst silica gel) | 166 mg | 30 | 9 | 73% |
| Silica 646 | Control (underivatized) | 142 mg | 110 | 17 | |
| Silica 646 | CoPcTS | | 58 | 27 | 63% |
| Silica 646 | Control | | 157 | 17 | |

Any conventional or modified cigarette filter may incorporate the CoPc-modified particles. The surface-modified particles can be incorporated in or on a support such as paper (e.g., liner, plug wrap or tipping paper) or cellulose acetate that is located along and/or within a filter portion of a cigarette. For example, the surface-modified particles can be loaded onto a support such as lightly or tightly folded paper and inserted into a hollow portion of the cigarette filter. The particles can also be located within a hollow cavity sandwiched between conventional cigarette filter elements such as plugs of cellulose acetate. The support is preferably in the form of a sheet material such as crepe paper, filter paper, or tipping paper. However, other suitable support materials such as organic or inorganic cigarette compatible materials can also be used.

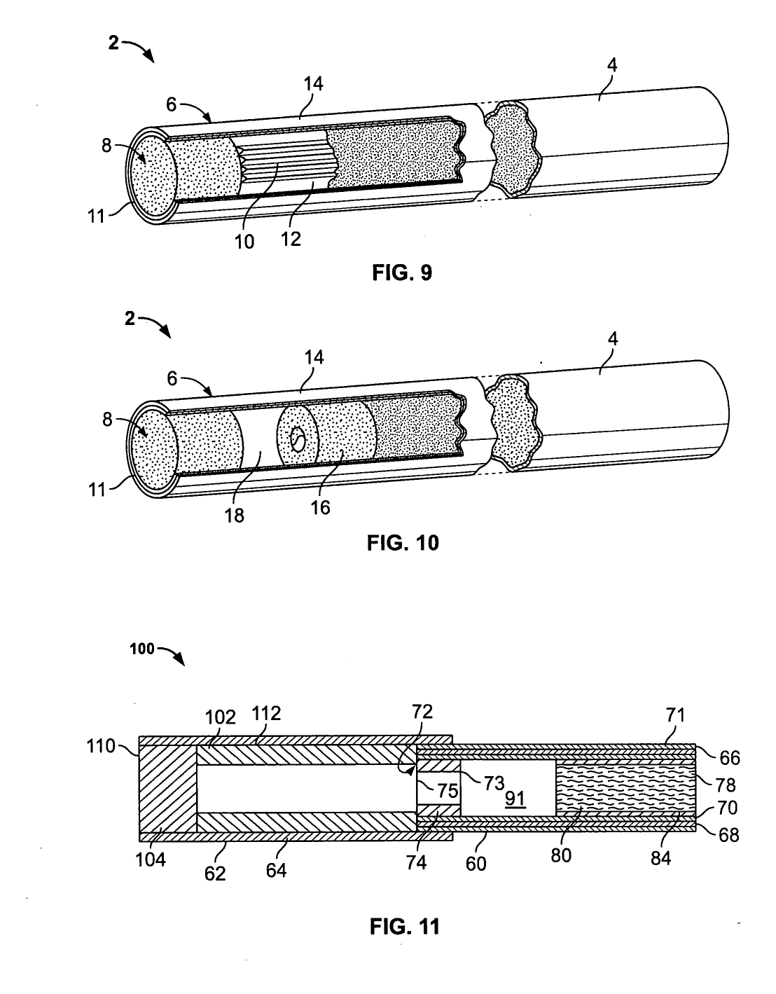

FIG. 9 illustrates a cigarette 2 having a tobacco rod 4, a filter portion 6, and a mouthpiece filter plug 8. According to an embodiment, CoPc-modified particles can be loaded onto folded paper 10 and inserted into a hollow cavity such as the interior of a free-flow sleeve 12 forming part of the filter portion 6. The paper 10 can be used in forms other than as a folded sheet. For instance, the paper 10 can be used as one or more individual strips, a wound roll, etc. In whichever form, a desired amount of CoPc-modified particles can be provided in the cigarette filter portion by adjusting the amount of particles coated per unit area of the paper and/or the total area of coated paper employed in the filter (e.g., higher amounts of surface-modified adsorbent can be provided simply by using larger pieces of coated paper). In the cigarette shown in FIG. 9, the filter portion 6 may be held together by a filter overwrap 11, and the tobacco rod 4 and the filter portion 6 can be joined together with tipping paper 14.

FIG. 10 shows a cigarette 2 comprised of a tobacco rod 4 and a filter portion 6 in the form of a plug-space-plug filter having a mouthpiece filter 8, a plug 16, and a space 18. The plug can comprise a tube or solid piece of material such as polypropylene or cellulose acetate fibers. The tobacco rod 4 and the filter portion 6 are joined together with tipping paper 14. The filter portion 6 may include a filter overwrap 11. Surface-modified adsorbent particles can be incorporated in and/or on the filter overwrap 11 such as by being coated thereon. Alternatively, the surface-modified adsorbent particles can be incorporated in the mouthpiece filter 8, in the plug 16 and/or in the space 18. Moreover, the surface-modified adsorbent particles can be incorporated in any element of the filter portion of a cigarette.

The surface-modified adsorbent particles can be incorporated in a hollow portion of a cigarette filter. For example, some cigarette filters have a plug/space/plug configuration in which the plugs comprise a fibrous filter material (e.g., polypropylene or cellulose acetate fibers) and the space is simply a void between the two filter plugs. That void can be filled with the surface-modified particles.

The CoPc-modified adsorbent particles can be incorporated into filter paper and/or fibrous filter media in a number of ways. For example, the surface-modified particles can be mixed with a liquid such as water to form a slurry. The slurry can then be coated onto pre-formed filter paper or a filter rod and allowed to dry. The filter paper or filter rod can then be incorporated into the filter portion of a cigarette. Alternatively, the surface-modified adsorbent particles can be added to filter paper or to a filter rod during their respective manufacturing processes. For example, the adsorbent particles can be mixed with bulk cellulose to form a cellulose pulp mixture, and the mixture can be then formed into filter paper.

In another embodiment, the CoPc-modified particles are incorporated in a filter portion of a cigarette for use with an electrical smoking device as described in commonly owned U.S. Pat. No. 5,692,525, the entire content of which is hereby incorporated by reference. FIG. 11 illustrates one type of construction of a cigarette 100 that can be used with an electrical smoking device. As shown, the cigarette 100 includes a tobacco rod 60 and a filter portion 62 joined by tipping paper 64. The filter portion 62 preferably contains a tubular free-flow filter element 102 and a mouthpiece filter plug 104. The free-flow filter element 102 and mouthpiece filter plug 104 may be joined together as a combined plug 110 with plug wrap 112. The tobacco rod 60 can have various forms incorporating one or more of the following items: an overwrap 71, another tubular free-flow filter element 74, a cylindrical tobacco plug 80 preferably wrapped in a plug wrap 84, a tobacco web 66 comprising a base web 68 and tobacco flavor material 70, and a void space 91. The free-flow filter element 74 provides structural definition and support at the tipped end 72 of the tobacco rod 60. At the free end 78 of the tobacco rod 60, the tobacco web 66 together with overwrap 71 is wrapped about cylindrical tobacco plug 80. Various modifications can be made to a filter arrangement for such a cigarette incorporating the surface-modified adsorbent particles.

In such a cigarette, the surface-modified adsorbent particles can be incorporated in various ways such as by being loaded onto paper or other substrate material that is fitted into the passageway of the tubular free-flow filter element 102 therein. The surface-modified adsorbent particles may also be deployed on a liner or a plug in the interior of the tubular free-flow filter element 102. Alternatively, or in addition, the surface-modified adsorbent particles can be incorporated into the fibrous wall portions of the tubular free-flow filter element 102 itself. For instance, the tubular free-flow filter element or sleeve 102 can be made of suitable materials such as polypropylene or cellulose acetate fibers and the surface-modified adsorbent particles can be mixed with such fibers prior to or as part of the sleeve forming process.

The surface-modified adsorbent particles can be incorporated into the mouthpiece filter plug 104 instead of in the element 102. However, as in the previously described embodiments, the surface-modified adsorbent particles may be incorporated into more than one component of a filter portion such as by being incorporated into the mouthpiece filter plug 104 and into the tubular free-flow filter element 102. The filter portion 62 of FIG. 10 can be modified to create a void space into which the surface-modified adsorbent particles can be inserted.

When CoPc-modified particles are used in filter paper, the particles may have an average particle size of 10 to 100 microns, preferably 30 to 80 microns. When the surface-modified adsorbent is used in filter fibers or other mechanical supports, larger particles may be used. Such particles preferably have a mesh size from 10 to 70, and more preferably from 20 to 50 mesh.

The amount of CoPc-modified adsorbent employed in a cigarette filter by way of incorporation on a suitable support such as filter paper and/or filter fibers depends on the amount of nitric oxide in the tobacco smoke and the amount of nitric oxide desired to be removed.

The following examples provide a description of a synthesis of various cobalt (II) phthalocyanine compounds. It is to be understood that the procedures described are not necessarily optimized and are provided for exemplary purposes only.

### EXAMPLE 1

### Synthesis of Cobalt (II) Phthalocyanine Tetracarboxylic Acid

A mixture of 4-carboxyphthalic anhydride (trimellitic acid anhydride) (96.45 g, 0.502 mole), urea (200.17 g, 3.333 moles), cobalt(II) chloride hexahydrate (31.28 g, 0.131 moles), ammonium chloride (4.07 g, FW 53.49; catalyst) and ammonium molybdate [(NH₄)₆Mo₇O₂₄.4H₂O, FW 1235.86] (1.84 g, catalyst) was stirred in a 3-neck standard taper 24/40 1 liter round bottom flask along with 749.82 g of 1,2,4-trichlorobenzene (heat transfer medium) and heated by a silicone oil bath maintained at around 191° C. for about 2 hours. After cooling overnight, the colorless heat transfer medium was decanted off. The solids were rinsed with 95% ethanol (250 mL) and then water (2×250 mL). The solid lump product crumbled as it was successively rinsed with ethyl acetate (2×250 mL), 95% ethanol (250 mL) and water (250 mL). After being transferred to a Buchner funnel, the solids were finally rinsed with ethyl acetate (250 mL) and 95% ethanol (250 mL), and dried partially under suction. The crude solids, which gave a total yield of 122.97 g were bottled.

Further processing involved reflux with hydrochloric acid, leaching the resulting solids with ammonium hydroxide, treating the ammoniacal solution with sodium hydroxide, and boiling off much of the water and ammonia. Acidification of the resulting mixture with hydrochloric acid, followed by repeated rinsing of the solids by centrifugation and decantation led to pasty product which was dried in air to give purple lumps.

### EXAMPLE 2

### Synthesis of Cobalt (II) Phthalocyanine Tetrasulfonic Acid Tetraammonium Salt

50% aqueous “4-sulfophthalic acid” (containing some isomeric 3-sulfophthalic acid) (295.82 g, nominal content 147.91 g), cobalt chloride hexahydrate (44.77 g), ammonium chloride (18.07 g), and urea (62.36 g) were azeotroped with 500 mL of toluene to remove as much water from the system as possible. After cooling, the toluene was decanted off, and the dark purple sticky solids were further diluted with urea (462.53 g) and ammonium molybdate catalyst (1.21 g) and ammonium chloride (16.57 g). 1,2,4-Trichlorobenzene (1500 mL) was heated in a 5 liter round-bottom flask to about 170° C., and the mixed starting materials were added in portions over about 30 minutes, while maintaining the reaction temperature in the range of 158° C. to 205° C. Vigorous boiling and gas evolution occurred as the portions were added, but subsided quickly. The mixture was maintained at a temperature of about 175° C. for 3 hours. After cooling overnight, the trichlorobenzene was decanted off. Water (2000 mL) was added to the residue, and most of the remaining trichlorobenzene was removed by steam distillation. On cooling, much of the cyanuric acid byproduct crystallized, and was removed by suction filtration. Traces of trichlorobenzene were removed by extraction with hexane (2×250 mL). The aqueous phase was concentrated to small volume by rotary evaporation, and treated with ammonium chloride (75.93 g) and 95% ethanol, and crystallized from about 2 liters of total volume. The solids were filtered off, and rinsed with 95% ethanol (3×500 mL). After drying in air, the solids were weighed, yielding 235.26 g.

Further purification: An aliquot (140.07 g) of the solids synthesized above was dissolved in 300 mL of water to which 100 mL of concentrated hydrochloric acid was added. The mixture was refluxed until gas evolution had subsided, after about 3.5 hours. On standing overnight, the product partly crystallized, and 1000 mL of 95% ethanol was added gradually. The solids were then filtered off, rinsed with 95% ethanol and dried in air, yielding 51.21 g.

### EXAMPLE 3

### Synthesis of Sulfonated Cobalt (II) Phthalocyanine

Sulfonation of cobalt (II) phthalocyanine was carried out as follows: A 217.58 g of fuming sulfuric acid (“oleum”, 30% SO₃) was poured into a nitrogen-purged standard-taper Erlenmeyer flask. Cobalt (II) phthalocyanine (20.21 g, Aldrich) was added in portions to the magnetically-stirred oleum at room temperature. The mixture warmed spontaneously, thickened, then thinned again, and became easy to stir. The hotplate was heated to 55° C., and the mixture was heated for 2.5 hours, than allowed to cool to room temperature while stirring was maintained overnight. The mixture was poured carefully onto crushed ice causing a vigorous reaction. The crystallized product was suction filtered and dried. The yield was 26.92 g. A 0.5% stock solution was prepared from 2.53 grams of the product and 7.74 g of ammonium hydroxide, added to an amount of water such that the total weight of the solution was 500.01 g.

While the disclosed embodiments have been described in reference to preferred embodiments, it is to be understood that variations and modifications may be resorted to as will be apparent to those skilled in the art. Such variations and modifications are to be considered within the purview and scope of the claims appended hereto.

We claim:

1. A nitric oxide sorbent comprising a functionalized cobalt (II) phthalocyanine-modified porous substrate, wherein the substrate is capable of nitric oxide adsorption from a gas stream.

2. A method of making the sorbent of claim 1 wherein the porous substrate is modified by impregnating or grafting functionalized cobalt (II) phthalocyanine molecules onto the substrate.

3. A method of using the sorbent of claim 1 wherein a concentration of nitric oxide in a gas stream is reduced by exposing the gas stream to the sorbent.

4. A cigarette filter element comprising the sorbent of claim 1 wherein the sorbent is effective to reduce levels of nitric oxide in mainstream smoke of a cigarette comprising the cigarette filter element.

5. The filter element of claim 4 comprising 10 to 200 mg of the sorbent.

6. The sorbent of claim 1 wherein the substrate is selected from the group consisting of adsorbent carbon, activated carbon, silica gel, zeolites, clays, mesoporous silicates and mixtures thereof.

7. The sorbent of claim 1 wherein the substrate is an imidazole-functionalized silica gel, a pyridine-functionalized silica gel or an optionally acid-washed activated carbon.

8. The sorbent of claim 1 wherein the cobalt (II) phthalocyanine comprises sulfonated cobalt (II) phthalocyanine, carboxylated cobalt (II) phthalocyanine, phosphorated cobalt (II) phthalocyanine, or any combination thereof.

9. A method of making the sorbent of claim 1 wherein the porous substrate is modified by a cobalt (II) phthalocyanine compound comprising a member of the group consisting of one or more of cobalt (II) phthalocyanine tetracarboxylic acid, cobalt (II) phthalocyanine tetrasulfonic acid, cobalt (II) phthalocyanine tetraphosphoric acid and cobalt (II) phthalocyanine tetraphosphonic acid.

10. A method of making the sorbent of claim 1 wherein the porous substrate is derivatized with a cobalt (II) phthalocyanine compound containing one or more carboxylic acid groups and/or one or more sulfonic acid groups and/or one or more phosphonic acid groups, or any combination thereof.

11. A method of making the sorbent of claim 1 wherein the porous substrate is mixed with a liquid solution containing a cobalt (II) phthalocyanine compound under conditions effective to incorporate cobalt (II) phthalocyanine molecules from the solution into the pores of the substrate.

12. A method of making the sorbent of claim 1 wherein the porous substrate is mixed with a boiling ammoniacal solution containing a cobalt (II) phthalocyanine compound soluble in an alkaline solution.

13. The sorbent of claim 1 wherein the cobalt (II) phthalocyanine is incorporated in the substrate by a total loading of up to the lesser of saturation or about 10% by weight.

14. The sorbent of claim 1 wherein the substrate is in the form of fibers, particles, granules and/or beads.

15. The sorbent of claim 7 comprising activated carbon loaded with up to 15 weight % of functionalized cobalt (II) phthalocyanine or silica gel loaded with up to 15 weight % of functionalized cobalt (II) phthalocyanine.

16. The sorbent of claim 14 wherein the fiber, particle, granule and/or bead sizes range from about 35×60 mesh to about 20×50 mesh.

17. The sorbent of claim 1 wherein the porous substrate has an average pore size of about 20 to about 500 Angstroms.

18. The sorbent of claim 6, wherein the substrate comprises silica gel particles of an average size of about 10 to 500 microns and an average pore size of about 20 Angstroms or greater.

19. The sorbent of claim 6, wherein a loading of imidazole in the silica gel corresponds to a range from about 1×10⁻³ to about 3×10⁻³ gram-atoms of nitrogen per gram of silica gel.

20. A cigarette filter element wherein the fibers, particles, granules and/or beads of claim 14 are incorporated in or on a liner, a plug, a plug wrap, tipping paper, fibrous filter media, fibrous wall portions of a filter element, or cellulose acetate located along and/or within a filter element.

21. A cigarette filter element wherein the fibers, particles, granules and/or beads of claim 14 are incorporated within a hollow cavity sandwiched between conventional cigarette filter elements such as plugs of cellulose acetate.

22. A cigarette for use with an electrical smoking device comprising the cigarette filter element of claim 4.

23. A gas sensor comprising the sorbent of claim 1.

24. A nitric oxide sorbent comprising an activated carbon substrate, wherein the substrate is:
optionally acid-washed, and
subsequently modified by a derivatized cobalt (II) phthalocyanine compound,
such that the substrate is capable of nitric oxide adsorption from a gas stream.

25. A cigarette filter element wherein the sorbent of claim 24 is incorporated in or on a liner, a plug, a plug wrap, tipping paper, fibrous filter media, fibrous wall portions of a filter element, cellulose acetate located along and/or within a filter element, or within a hollow cavity sandwiched between conventional cigarette filter elements such as plugs of cellulose acetate.

26. A cigarette comprising the cigarette filter element of claim 25.

27. A nitric oxide sorbent comprising a silica gel substrate, wherein the substrate is:
imidazole-functionalized and
subsequently modified by a derivatized cobalt (II) phthalocyanine compound, such that the substrate is capable of nitric oxide adsorption from a gas stream.

28. A cigarette filter element wherein the sorbent of claim 27 is incorporated in or on a liner, a plug, a plug wrap, tipping paper, fibrous filter media, fibrous wall portions of a filter element, cellulose acetate located along and/or within a filter element, or within a hollow cavity sandwiched between conventional cigarette filter elements such as plugs of cellulose acetate.

29. A cigarette comprising the cigarette filter element of claim 28.
